(19) United States
(12) Patent Application Publication
(10) Pub. No.: US 2021/0075680 A1
(43) Pub. Date: Mar. 11, 2021

(54) METHODS, SYSTEMS, AND DEVICES FOR EFFICIENT REUSE OF INTERNET OF THINGS (IOT) DEVICES DEPLOYED IN TEMPORARY APPLICATIONS

(71) Applicant: Brickyard Wireless, L.L.C. (dba Logistimatics), Greensboro, NC (US)

(72) Inventors: Brendan Younger, Greensboro, NC (US); Matt Hannam, Brown Summit, NC (US); Paul Cameron, Oak Ridge, NC (US)

(21) Appl. No.: 17/016,733

(22) Filed: Sep. 10, 2020

Related U.S. Application Data
(60) Provisional application No. 62/898,569, filed on Sep. 11, 2019.

(51) Int. Cl. H04L 12/24; G16Y 30/00; G06Q 30/00; G06Q 20/14; G06Q 20/30; G06Q 20/12; G06F 21/10; H04L 29/06; G06K 7/14; G06K 7/10; G01S 19/14

(52) U.S. Cl. CPC H04L 41/0853; G16Y 30/00; G06Q 30/0185; G06Q 20/145; G06Q 20/308; G06Q 20/1235; G16Y 10/45; H04L 63/102; H04L 63/108; G06K 7/1413; G06K 7/1417; G06K 7/10297; G01S 19/14; G06F 21/10

(57) ABSTRACT

Disclosed herein are methods, systems, and devices for solving the problem of efficient reuse of internet-of-things (IoT) devices deployed in temporary applications. According to one embodiment, a method is implemented on a computing device. The method includes receiving, over a wide area network (WAN) from a mobile device, a device identification (ID) associated with an IoT device. The method further includes determining first digital rights management (DRM) privileges for the IoT device based on the device ID. The first DRM privileges are associated with a first entity and a first timestamp. The method further includes receiving, over the WAN from the mobile device, a first request to provide second DRM privileges for the IoT device. The second DRM privileges are associated with a second entity and a second timestamp. The method further includes granting the second DRM privileges based at least partially on a permission from the first entity.

### PRIORITY CLAIM

This application claims priority to U.S. Provisional Patent Application Ser. No. 62/898,569, titled “METHODS, SYSTEMS, AND DEVICES FOR EFFICIENT REUSE OF INTERNET OF THINGS (IOT) DEVICES DEPLOYED IN TEMPORARY APPLICATIONS,” filed Sep. 11, 2019, the disclosure of which is incorporated herein by reference in its entirety.

### TECHNICAL FIELD

The present invention relates generally to management of internet-of-things (IoT) devices. More specifically this disclosure presents methods, systems, and devices for efficient reuse of IoT devices deployed in temporary applications.

### BACKGROUND

Internet-of-things (IoT) devices are become increasing more sophisticated including more options for wide area network (WAN), local area network (LAN), personal area network (PAN), and near field communication (NFC) capabilities. These IoT devices are including many more high-performance sensor capabilities including environmental, location, etc. As the performance of these IoT devices continue to increase, so do the costs.

While many uses of these IoT device are long-term and/or semi-permanent, other deployments may include temporary applications. Such devices may include tracking devices for shipments.

As such, new methods, systems, and devices are needed for more efficient reuse of IoT devices deployed in temporary applications.

### SUMMARY

This disclosure presents methods, systems, and devices for solving the problem of efficient reuse of internet-of-things (IoT) devices deployed in temporary applications. According to one embodiment, a method is implemented on at least one computing device. The method includes receiving, over a wide area network (WAN) from a mobile device, a device identification (ID) associated with an IoT device. The method further includes determining first digital rights management (DRM) privileges for the IoT device based on the device ID. The first DRM privileges are associated with a first entity and a first timestamp. The method further includes receiving, over the WAN from the mobile device, a first request to provide second DRM privileges for the IoT device. The second DRM privileges are associated with a second entity and a second timestamp. The method further includes granting the second DRM privileges based at least partially on a permission from the first entity.

In some embodiments, the IoT device may be a global positioning system (GPS) tracking device. The first DRM privileges may include read access limited to first location data recorded by the IoT device between the first timestamp and the second timestamp and the second DRM privileges may include read access limited to second location data recorded by the IoT device after the second timestamp. In certain embodiments, the first DRM privileges may further include read access limited to first environmental data recorded by the IoT device between the first timestamp and the second timestamp and the second DRM privileges include read access limited to second environmental data recorded by the IoT device after the second timestamp.

In some embodiments, the first DRM privileges may include read access limited to first dynamic position data recorded by the IoT device between the first timestamp and the second timestamp and the second DRM privileges may include read access limited to second dynamic position data recorded by the IoT device after the second timestamp. In certain embodiments, the first and second position data may be recorded at least partially by a three-axis accelerometer included within the IoT device. The first and second position may also be recorded at least partially by a three-axis gyroscope.

In some embodiments, the first DRM privileges may include read access limited to first device health data recorded by the IoT device between the first timestamp and the second timestamp. The second DRM privileges may also include read access limited to second device health data recorded by the IoT device after the second timestamp. In certain embodiments, the first device health data may include a first battery status and the second device health data include a second battery status. The first device health data may also include a first partial failure status of the IoT device, and the second device health data may include a second partial failure status of the IoT device.

In some embodiments, the method further includes transmitting to a first backend server a first entity unique ID and the second timestamp, wherein the first backend server is configured for customer billing management.

The method may further include receiving WAN usage information associated with the IoT device between the first timestamp and the second timestamp and transmitting to the first backend server the WAN usage information.

In some embodiments, the computing device is at least one server. The computing device may also be hosted in a cloud computing environment. The mobile device may be at least one of a smart phone, a smart watch, a tablet, a laptop, or the like.

In some embodiments, the IoT device includes a machine readable code and the mobile device may be configured to determine the device ID based on the machine readable code. In certain embodiments, the machine readable code may be stored within at least one of a barcode, a QR code, a near field communication (NFC) tag, or the like. In certain embodiments, the mobile device may be configured to receive the device ID over a Bluetooth® Low Energy (BLE) connection between the mobile device and the IoT device. Non-static data such as current ownership or lack thereof may be communicated via NFC or BLE without the need to access the WAN.

In some embodiments, the IoT device may include a first subscriber identity module (SIM) card and the device ID may be associated with the SIM card. The device ID may also be associated with at least one of an integrated circuit card identifier (ICCID), an international mobile subscription identification number (IMSI) associated with the SIM card, or the like.

In some embodiments, the method may further include adjusting a first entity device credits value based on the second timestamp. The first entity device credits value may have been previously adjusted based on the first timestamp. The method may further include transmitting to a first backend server a first entity unique ID and the first entity device credits value. In certain embodiments the first backend server may be configured for customer billing management.

In some embodiments, the permission may be granted from another mobile device associated with the first entity. The method may further comprising receiving, over the WAN, the permission from the another mobile device. The permission may include the device ID. The method may further include transmitting, over the WAN, a second request to the another mobile device to grant the permission and the second request includes the device ID.

In some embodiments, the first entity may be a business entity. In other embodiments, the first entity may be a user associated with the another mobile device. In some embodiments, the second entity may also be a business entity. In other embodiments, the second entity may be a user associated with the mobile device.

According to another embodiment, a computing device includes a memory and at least one processor configured to provide a method. The method includes receiving, over a wide area network (WAN) from a mobile device, a device identification (ID) associated with an IoT device. The method further includes determining first digital rights management (DRM) privileges for the IoT device based on the device ID. The first DRM privileges are associated with a first entity and a first timestamp. The method further includes receiving, over the WAN from the mobile device, a first request to provide second DRM privileges for the IoT device. The second DRM privileges are associated with a second entity and a second timestamp. The method also includes granting the second DRM privileges based at least partially on a permission from the first entity.

According to another embodiment, a non-transitory computer-readable storage medium stores instructions to be implemented on at least one computing device including at least one processor. The instructions when executed by the at least one processor cause the at least one computing device to provide a method. The method includes receiving, over a wide area network (WAN) from a mobile device, a device identification (ID) associated with an IoT device. The method further includes determining first digital rights management (DRM) privileges for the IoT device based on the device ID. The first DRM privileges are associated with a first entity and a first timestamp. The method further includes receiving, over the WAN from the mobile device, a first request to provide second DRM privileges for the IoT device. The second DRM privileges are associated with a second entity and a second timestamp. The method also includes granting the second DRM privileges based at least partially on a permission from the first entity.

In another embodiment, a mobile device is configured to provide a method for receiving information associated with an IoT device under DRM control. The method includes receiving a device ID associated with the IoT device. A first entity has first DRM privileges for information associated with the IoT device and the mobile device is associated with a second entity. The method further includes transmitting over a network to a server the device ID, a second entity unique ID, and a request for second DRM privileges for the second entity for the information associated with the IoT device. Next, the method includes receiving over the network from the server the second DRM privileges. The second DRM privileges are also associated with a timestamp and the timestamp is associated with a billing cycle for the second entity for usage of the IoT device. Next the method includes receiving over the network a first portion of the information associated with the IoT device and receiving from the IoT device a second portion of the information. The method further includes displaying the information on a GUI associated with the mobile device.

In some embodiments, the device ID may be received from the GUI.

In some embodiments, the IoT device may be a global positioning system (GPS) tracking device. The second DRM privileges may include read access limited to location data recorded by the IoT device after the timestamp. In certain embodiments, the second DRM privileges may further include read access limited to environmental data recorded by the IoT device after the timestamp.

In some embodiments, the second DRM privileges may also include read access limited to device health data recorded by the IoT device after the timestamp. In certain embodiments, the device health data may include a battery status of the IoT device. The device health data may also include a partial failure status of the IoT device.

In some embodiments, the IoT device may include a machine readable code and the mobile device may be configured to determine the device ID based on the machine readable code. In certain embodiments, the machine readable code may be stored within at least one of a barcode, a QR code, an NFC tag, or the like. In certain embodiments, the mobile device may be configured to receive the device ID over a BLE connection between the mobile device and the IoT device.

In some embodiments, the IoT device may include a first SIM card and the device ID may be associated with the SIM card. The device ID may also be associated with at least one of ICCID, an IMSI associated with the SIM card, or the like.

In some embodiments, the first entity may be a business entity. In other embodiments, the first entity may be a user associated with another mobile device. In some embodiments, the second entity may also be a business entity. In other embodiments, the second entity may be a user associated with the mobile device.

According to another embodiment, a mobile device includes a memory and at least one processor configured to provide a method for receiving information associated with an IoT device under DRM control. The method includes receiving a device ID associated with the IoT device. A first entity has first DRM privileges for information associated with the IoT device and the mobile device is associated with a second entity. The method further includes transmitting over a network to a server the device ID, a second entity unique ID, and a request for second DRM privileges for the second entity for the information associated with the IoT device. Next, the method includes receiving over the network from the server the second DRM privileges. The second DRM privileges are also associated with a timestamp and the timestamp is associated with a billing cycle for the second entity for usage of the IoT device. Next the method includes receiving over the network a first portion of the information associated with the IoT device and receiving from the IoT device a second portion of the information. The method further includes displaying the information on a GUI associated with the mobile device.

According to another embodiment, a non-transitory computer-readable storage medium stores instructions to be implemented on a mobile including at least one processor. The instructions when executed by the at least one processor cause the mobile device to provide a method for receiving information associated with an IoT device under DRM control. The method includes receiving a device ID associated with the IoT device. A first entity has first DRM privileges for information associated with the IoT device and the mobile device is associated with a second entity. The method further includes transmitting over a network to a server the device ID, a second entity unique ID, and a request for second DRM privileges for the second entity for the information associated with the IoT device. Next, the method includes receiving over the network from the server the second DRM privileges. The second DRM privileges are also associated with a timestamp and the timestamp is associated with a billing cycle for the second entity for usage of the IoT device. Next the method includes receiving over the network a first portion of the information associated with the IoT device and receiving from the IoT device a second portion of the information. The method further includes displaying the information on a GUI associated with the mobile device.

The features and advantages described in this summary and the following detailed description are not all-inclusive. Many additional features and advantages will be apparent to one of ordinary skill in the art in view of the drawings, specification, and claims presented herein.

### BRIEF DESCRIPTION OF THE DRAWINGS

The present embodiments are illustrated by way of example and are not intended to be limited by the figures of the accompanying drawings. In the drawings:

FIG. 1 depicts a flowchart illustrating a method implemented on a computing device for digital rights management (DRM) of an Internet of Things (IoT) device related to a first entity and a second entity in accordance with embodiments of the present disclosure.

FIG. 2 depicts a block diagram illustrating an IoT device in accordance with embodiments of the present disclosure.

FIG. 3 depicts a system diagram illustrating a server application executing on a server within a cloud computing environment in accordance with embodiments of the present disclosure.

FIG. 4 depicts a block diagram illustrating a mobile device that includes a camera for capturing a device ID of the IoT device of FIG. 2 in accordance with embodiments of the present disclosure.

FIG. 5 depicts a flowchart illustrating a method implemented on a mobile device for retrieving information under DRM control associated with the IOT device in accordance with embodiments of the present disclosure.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Disclosed herein are methods, systems, and devices related to the management of internet-of-things (IoT) devices including the efficient reuse of the IoT devices while deployed in temporary applications.

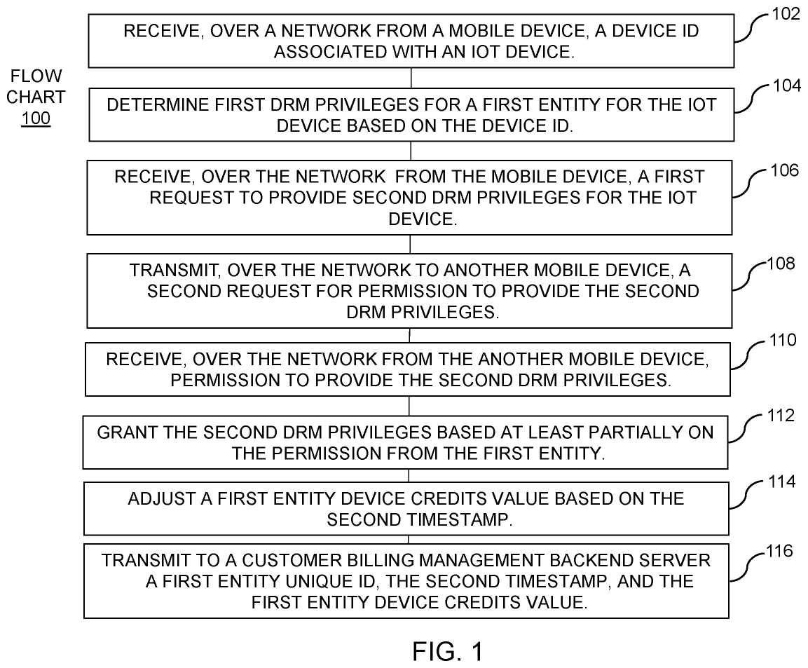

FIG. 1 depicts a flowchart 100 illustrating a method implemented on a computing device for digital rights management (DRM) of an IoT device related to a first entity and a second entity in accordance with embodiments of the present disclosure.

In step 102 the computing device is configured to receive, over a network, a device identification (ID) associated with the IoT device. The network may be a wireless network. For example, the wireless network may be a 2G network, a 3G network, a 4G network, a 5G network, or the like. The device ID may be represented as a machine readable code located on or within the IoT device. For example, the machine readable code may be a barcode, a QR code, a near field communication (NFC) tag, Bluetooth® Low Energy (BLE) advertisement packet, or the like. The device ID may also be stored in one or more databases and/or on one or more backend servers.

In step 104 the computing device is configured to determine first digital rights management (DRM) privileges for the IoT device based on the device ID. The first DRM privileges are associated with a first entity and a first timestamp. The first DRM privileges may include access to data recorded by the IoT device after the first timestamp. For example, the first DRM privileges may include read access limited to location data recorded by a global positioning system (GPS) receiver on the IoT device. The first DRM privileges may also include read access to environmental data recorded by the IoT device. The data may be available directly from the IoT device or may be available from one or more backend servers.

In step 106 the computing device is configured to receive, over the network from the mobile device, a first request to provide second DRM privileges for the IoT device. The second DRM privileges are associated with a second entity and a second timestamp. The second DRM privileges may include access to data recorded by the IoT device after the second timestamp. This data may be available directly from the IoT device or may be available from one or more backend servers.

In step 108 the computing device is configured to transmit, over the network to another mobile device associated with the first entity, a second request for permission to provide the second DRM privileges. The second request may include the device ID and the second timestamp.

In step 110 the computing device is configured to receive, over the network from the another mobile device, permission to provide the second DRM privileges. The permission may include the device ID.

In step 112 the computing device is configured to grant the second DRM privileges based at least partially on the permission from the first entity.

In step 114 the computing device is configured to adjust a first entity device credits value based on the second timestamp. The first entity device credits value may have been previously adjusted based on the first timestamp.

In step 116 the computing device is configured to transmit to a customer billing management server a first entity unique ID, the second timestamp, and the first entity device credits value.

In other steps not shown in FIG. 1, the computing device may be configured to receive WAN usage information associated with the IoT device between the first timestamp and the second timestamp and configured to transmit the WAN usage information to one or more backend servers. Additionally, the one or more backend servers may include the customer billing server.

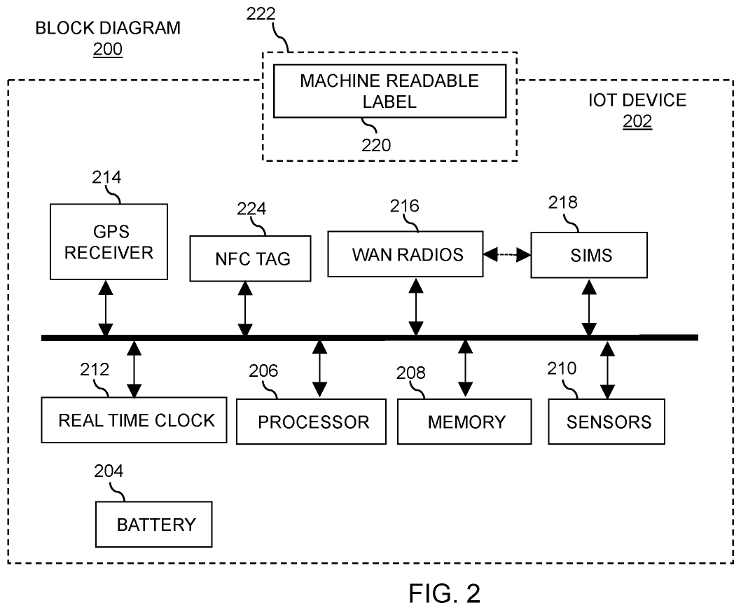

FIG. 2 depicts a block diagram 200 of an IoT device 202 in accordance with embodiments of the present disclosure. The IoT device 202 includes a battery 204, a processor 206, and a memory 208. In some embodiments the memory 208 or a portion of the memory 208 may be integrated with the processor 206. The memory 208 may include a combination of volatile memory and non-volatile memory. In some embodiments the processor 206 and the memory 208 may embedded in a microcontroller.

The IoT device 202 includes a plurality of sensors 210. The sensors 210 may include a microphone, a temperature detector, a humidity detector, a barometric detector, a stress detector, a proximity detector, an ambient light detector, a three-axis accelerometer, and/or a three-axis gyroscope. The three-axis accelerometer and the three-axis gyroscope may be configured to provide dynamic position data associated with movements of the IoT device 202. A plurality of analog-to-digital converters (ADCs) may be used to interface the sensors 210 with the processor 206. The ADCs may be integrated with the sensors 210 and/or the processor 206. The sensors 210 may also be configured to monitor a health status of the IoT device. For example the health status may include a status of the battery 204. The IoT device 202 also includes a real time clock 212 for providing timestamps associated with data recorded by the sensors 210. A global positioning system (GPS) receiver 214 is included with the IoT device 202 to provide location information.

The IoT device 202 includes one or more wide area network (WAN) radios 216 for communication over a wireless network. The wireless network may be a 2G network, a 3G network, a 4G network, a 5G network, or the like. The IoT device 202 also includes one or more subscriber identity module (SIM) cards. The IoT device 202 has a device ID and the device ID may be associated with the one or more SIM cards. For example, the device ID may be associated with at least one of an integrated circuit card identifier (ICCID), an international mobile subscription identification number (IMSI), or the like.

The IoT device 202 includes a machine readable label 220 and an enclosure 222. The enclosure 222 provides a surface area for the machine readable label 220. The machine readable label 220 contains the device ID and may be a barcode, a QR code, BLE advertisement packet, or the like. The machine readable label 220 is positioned on the enclosure 222 such that the device ID may be read by a camera on a mobile device. The device ID may also be provided in a human readable format on the machine readable label 220 (e.g. a printed serial number). In certain embodiments the IoT device 202 may include a near field communications (NFC) tag allowing the device ID to be obtained by an NFC receiver on a mobile device. In other embodiments, the device ID may be provided by a personal area network (PAN) interface not shown in FIG. 2. For example, the PAN interface may be a BLE interface®.

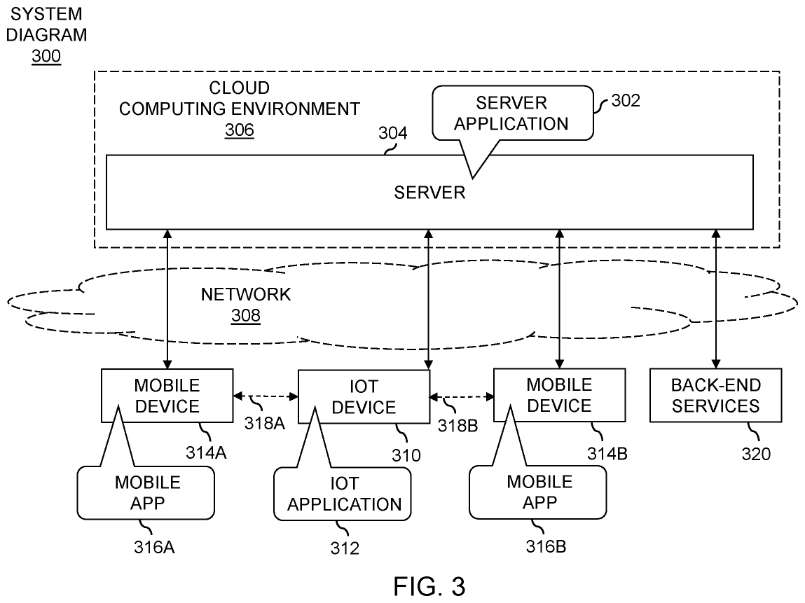

FIG. 3 depicts a system diagram 300 illustrating a server application 302 executing on a server 304 within a cloud computing environment 306 in accordance with embodiments of the present disclosure. The server application 302 is configured to provide the method depicted in the flowchart 100 of FIG. 1. The cloud computing environment 306 may be a portion of the Microsoft Azure® cloud computing environment, the Amazon Web Services® (AWS) cloud computing environment, or the like. The server 304 may be implemented as a virtual server such as an Ubuntu® server. The server may also be configured to be hosted within a virtual container. For example, the virtual container may be the Docker® virtual container or the like. In some embodiments, the virtual server and/or virtual container may be distributed over a plurality of hardware servers using hypervisor technology.

A network 308 provides connectivity between the server 304, an IoT device 310, and mobile devices 314A and 314B. The network 208 may be a wireless network and may include 2G, 3G, 4G, and/or 5G technologies. The network 208 may include the Internet.

The IoT device 310 may include all or at least a portion of the IoT device 202 of FIG. 2. The IoT device 310 executes an IoT application 312 to provide recorded data (e.g. location, temperature, microphone, etc.) with time stamps to the server 304 over the network 308. In some embodiments, the IoT application 312 may provide read access of the recorded data to mobile devices 314A and 314B directly over the network 308 or via short range communication (e.g. NFC and/or BLE 318A and 318B).

The mobile devices 314A and 314B are representative of the mobile device and the another mobile device described in the method of the flowchart 100 of FIG. 1. Specifically, the mobile devices 314A and 314B are configured to execute mobile apps 316A and 316B allowing read access/display of data recorded by the IoT device 310, read the device ID, and request/obtain DRM privileges associated with the IoT device 310.

The network 308 may also provide connectivity between the server 304 and back-end services 320. The back-end services 320 include the one or more servers of FIG. 1 (e.g. the customer billing server).

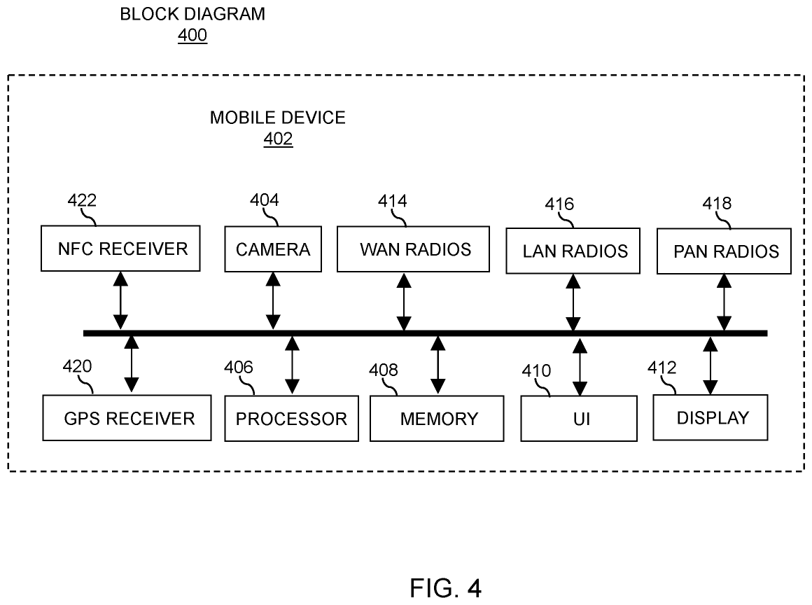

FIG. 4 depicts a block diagram 400 illustrating a mobile device 402 that includes a camera 404 for capturing the device ID of the IoT device 202 of FIG. 2 in accordance with embodiments of the present disclosure. The mobile device 402 is representative the mobile device 314A and/or 314B of FIG. 3 and may be a smart phone (e.g. cell phone), a tablet, a laptop, a smart watch, or the like.

The mobile device 402 also includes a processor 406 and a memory 408. In some embodiments the memory 408 or a portion of the memory 408 may be integrated with the processor 406. The memory 408 may include a combination of volatile memory (e.g. random access memory) and non-volatile memory (e.g. flash memory). In certain embodiments, the processor 406 may be a mobile processor such as the Qualcomm® Snapdragon® mobile processor. For example, the processor 406 may be the Snapdragon® 855 mobile processor. The mobile device 402 also includes a user interface (UI) 410 and a display 412. The UI 410 and the display 412 may be integrated within a touchpad display.

The mobile device 402 includes WAN radios 414, LAN radios 416, and PAN radios 418. The WAN radios 414 may include 2G, 3G, 4G, and/or 5G technologies. The LAN radios 416 may include Wi-Fi technologies such as 802.11a, 802.11b/g/n, and/or 802.11ac circuitry. The PAN radios 418 may include Bluetooth® and/or BLE technologies, and may also be used to read device IDs. The mobile device also includes a GPS receiver for identifying and/or verifying its location.

The memory 408 includes program instructions (i.e. one or more mobile apps) when executed by the processor 406 allow the mobile device 402 to access and display data recorded by IoT devices, read device IDs associated with the IoT devices using the camera 404 and/or the NFC receiver, and request/obtain DRM privileges associated with the IoT devices.

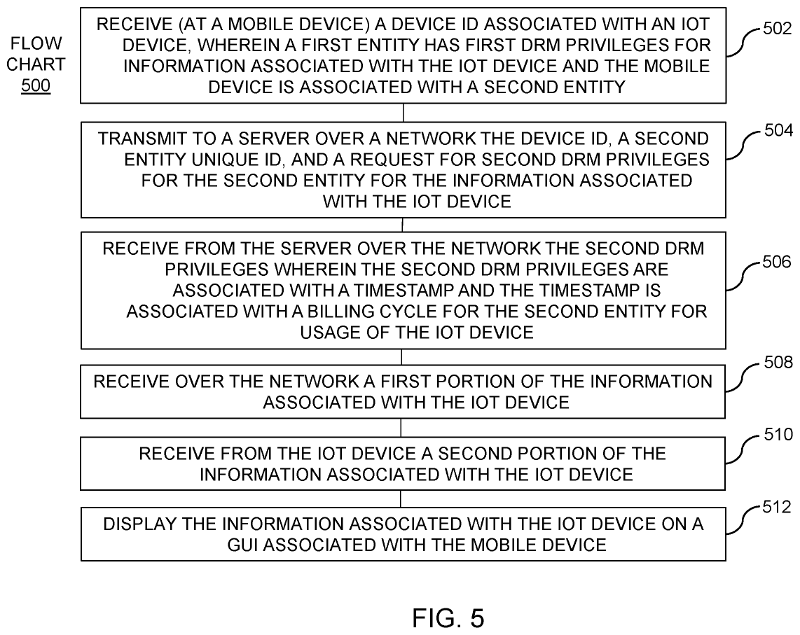

FIG. 5 depicts a flowchart 500 illustrating a method implemented on a mobile device (e.g. the mobile device of FIG. 4) for receiving information associated with an IoT device under DRM control (e.g. the IoT device of FIG. 2) in accordance with embodiments of the present disclosure.

In step 502, the mobile device receives a device ID associated with the IoT device. The device ID may be represented as a machine readable code located on or within the IoT device. For example, the machine readable code may be a barcode, a QR code, an NFC tag, a BLE advertisement packet, or the like. The device ID may also be received via a GUI associated with the mobile device (e.g. entered by a user of the mobile device). At time of receiving the device ID, the IoT device has first DRM privileges for accessing the information associated with the IoT device. The first DRM privileges are associated with a first entity and the first entity is not associated with the mobile device. The mobile device is associated with a second entity. The first entity and/or the second entity may or may not be business entities. The first DRM privileges may include read access limited to location data recorded by a GPS receiver on the IoT device. The first DRM privileges may also include read access to environmental data recorded by the IoT device. The data (i.e. information) may be available directly from the IoT device or may be available from one or more backend servers.

In step 504, the mobile device transmits over a network to a server the device ID, a second entity unique ID, and a request for second DRM privileges to be established for the second entity to receive the information associated with the IoT device. The network may be a wireless network. For example, the wireless network may be a 2G network, a 3G network, a 4G network, a 5G network, or the like.

In step 506, the mobile device receives over the network from the server second DRM privileges for the second entity to gain access to the information associated with the IoT device. The second DRM privileges are associated with a timestamp and the timestamp is associated with a billing cycle for the second entity for usage of the IoT device. The second DRM privileges may also include read access limited to location data recorded by the GPS receiver on the IoT device. The first DRM privileges may also include read access to environmental data recorded by the IoT device. The data may also only be available as recorded by the IoT device for times after the timestamp.

In step 508, the mobile device receives a first portion of the information for the IoT device over the network.

In step 510, the mobile device receives a second portion of the information from the IoT device. The mobile device may receive the second portion of the information via a Bluetooth® signal, a Wi-Fi signal, or the like.

In step 512, the mobile device displays the information via the GUI.

In certain embodiments (e.g. shipment tracking) the previously described methods, devices, and systems may provide:
1. Battery powered tracker with GPS and cellular antenna which periodically obtains a GPS position and reports its location to a central server over an available cellular network.
2. Barcode/QR code on tracker to uniquely identify it. Human readable serial number as well.
3. Mobile phone application which may:
   a. Scan barcode on device and accept payment for exclusive use of the tracker for a fixed period of time
   b. Accept input of planned time and location of shipment completion as well as additional information such as shipment description or associated tracking numbers (i.e. production lot number)
   c. Generate a shipment tracking number that allows bearer to see the locations of the device for the agreed upon above length of time. This tracking number/link can be shared with other people as well. Viewing can happen on website or mobile app.
   d. Show current and previous locations of the tracker to authorized users (those in possession the shipment tracking number or those who purchased access to the tracker)
   e. Inform user via mobile push notifications, text message, or email when the tracker will/will not reach its destination in time
   f. Invite other users to view the tracker's locations
4. Backend server and billing system which keeps track of which user(s) can see the location of the tracker for a given time period. The system also associates/disassociates the additional shipment information to the tracker during its paid usage period.
5. Billing system capable of applying credits to original purchaser of the tracker when it is re-used by a different person/account. These credits can be used to purchase additional trackers.
6. A buyback program whereby users can ship a used/found tracker back to Logistimatics for credits towards additional trackers or tracker usage.
7. After shipment is complete, provide a map-based snapshot of all the relevant information from the duration of the shipment that can be retrieved by anyone with the shipment tracking number. This digital artifact can be emailed or viewed on any web browser.
8. During periods of non-use, the SIM card must be kept active, which means keeping an IMSI number registered on the SIM. Generally speaking, an active IMSI costs money each month. When in an inactive state, the SIM card can be re-programmed to have a cheaper IMSI. When in active use, the IMSI can be changed to be one with a higher monthly cost but cheaper data rates or better carrier roaming agreements.
9. At any time, a user can scan the barcode on the tracker to look up whether it's in use or not. If it is in use, they can anonymously request access to the tracking data from the current owner.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including object oriented and/or procedural programming languages. For example, programming languages may include, but are not limited to: Ruby, JavaScript, Java, Python, Ruby, PHP, C, C++, C#, Objective-C, Go, Scala, Swift, Kotlin, OCaml, or the like.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method implemented on at least one computing device; the method comprising:
receiving, over a wide area network (WAN) from a mobile device, a device identification (ID) associated with an Internet-of-Things (IoT) device;
determining first digital rights management (DRM) privileges for the IoT device based on the device ID, wherein the first DRM privileges are associated with a first entity and a first timestamp;
receiving, over the WAN from the mobile device, a first request to provide second DRM privileges for the IoT device, wherein the second DRM privileges are associated with a second entity and a second timestamp; and
granting the second DRM privileges based at least partially on a permission from the first entity.

2. The method of claim 1, wherein:
the IoT device is a global positioning system (GPS) tracking device;
the first DRM privileges include read access limited to first location data recorded by the IoT device between the first timestamp and the second timestamp; and
the second DRM privileges include read access limited to second location data recorded by the IoT device after the second timestamp.

3. The method of claim 2, wherein:
the first DRM privileges further include read access limited to first environmental data recorded by the IoT device between the first timestamp and the second timestamp; and
the second DRM privileges include read access limited to second environmental data recorded by the IoT device after the second timestamp.

4. The method of claim 2, wherein:
the first DRM privileges further include read access limited to first dynamic position data recorded by the IoT device between the first timestamp and the second timestamp; and
the second DRM privileges include read access limited to second dynamic position data recorded by the IoT device after the second timestamp.

5. The method of claim 2, wherein:
the first DRM privileges further include read access limited to first device health data recorded by the IoT device between the first timestamp and the second timestamp; and
the second DRM privileges include read access limited to second device health data recorded by the IoT device after the second timestamp.

6. The method of claim 5, wherein the first device health data includes a first battery status and the second device health data includes a second battery status.

7. The method of claim 1, wherein the second entity is a business entity.

8. The method of claim 1, wherein the second entity is a user associated with the mobile device.

9. The method of claim 1 further comprising transmitting to a first backend server a first entity unique ID and the second timestamp, wherein the first backend server is configured for customer billing management.

10. The method of claim 9 further comprising:
receiving WAN usage information associated with the IoT device between the first timestamp and the second timestamp; and
transmitting to the first backend server the WAN usage information.

11. The method of claim 1, wherein the computing device is at least one server.

12. The method of claim 1, wherein the computing device is hosted in a cloud computing environment.

13. The method of claim 1, wherein the mobile device is at least one of a smart phone, a smart watch, a tablet, or a laptop.

14. The method of claim 1, wherein:
the IoT device comprises a machine readable code; and
the mobile device is configured to determine the device ID based on the machine readable code.

15. The method of claim 1 further comprising:
adjusting a first entity device credits value based on the second timestamp, wherein the first entity device credits value was previously adjusted based on the first timestamp; and
transmitting to a first backend server a first entity unique ID and the first entity device credits value, wherein the first backend server is configured for customer billing management.

16. The method of claim 1, wherein the permission is granted from another mobile device associated with the first entity.

17. The method of claim 16 further comprising receiving over the WAN the permission from the another mobile device, wherein the permission includes the device ID.

18. The method of claim 17 further comprising transmitting, over the WAN, a second request to the another mobile device to grant the permission, wherein the second request includes the device ID.

19. A computing device comprising:
a memory; and
at least one processor configured for:
receiving, over a wide area network (WAN) from a mobile device, a device identification (ID) associated with an Internet-of-Things (IoT) device;
determining first digital rights management (DRM) privileges for the IoT device based on the device ID, wherein the first DRM privileges are associated with a first entity and a first timestamp;
receiving, over the WAN from the mobile device, a first request to provide second DRM privileges for the IoT device, wherein the second DRM privileges are associated with a second entity and a second timestamp; and
granting the second DRM privileges based at least partially on a permission from the first entity.

20. A non-transitory computer-readable storage medium, the non-transitory computer-readable storage medium storing instructions to be implemented on at least one computing device including at least one processor, the instructions when executed by the at least one processor cause the at least one computing device to perform a method of:
receiving, over a wide area network (WAN) from a mobile device, a device identification (ID) associated with an Internet-of-Things (IoT) device;
determining first digital rights management (DRM) privileges for the IoT device based on the device ID, wherein the first DRM privileges are associated with a first entity and a first timestamp;
receiving, over the WAN from the mobile device, a first request to provide second DRM privileges for the IoT device, wherein the second DRM privileges are associated with a second entity and a second timestamp; and
granting the second DRM privileges based at least partially on a permission from the first entity.
